(19) United States
(12) Patent Application Publication
(10) Pub. No.: US 2009/0319334 A1
(43) Pub. Date: Dec. 24, 2009

(54) INTEGRATING ENTERPRISE DATA AND SYNDICATED DATA

(75) Inventors: Navin Dhananjaya, Bangalore (IN); Saravanan Sengottaiyan, Sivagiri (IN); Ahmet Sinan Gurman, Plano, TX (US)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 12/267,363

(22) Filed: Nov. 7, 2008

(30) Foreign Application Priority Data
Jun. 19, 2008 (IN) 1490/CHE/2008

(51) Int. Cl. G06Q 10/00; G06Q 30/00

(52) U.S. Cl. 705/10; 705/7

(57) ABSTRACT

Enterprise data and syndicated data can be integrated by obtaining enterprise data, obtaining syndicated data from a syndicated data provider, performing various processing on the enterprise and syndicated data such as recast processing, fringe compensation, event identification, and/or event matching, and outputting results. A data integration framework for integrating enterprise data, syndicated data, and/or unstructured data can be provided. The framework can comprise a plurality of data extractors and a data integration module. The data integration module can be configured to perform syndicated data recast processing on the syndicated data, perform fringe compensation processing on the syndicated data, identify consumption events in the processed syndicated data, and match shipment events to consumption events. Results of the matching can be stored and reported.

### BACKGROUND

Organizations like consumer product manufacturers, suppliers and retailers have to constantly work with large amounts of data. This data reflects important aspects regarding the enterprise performance and the operational aspects of the organization and all the entities in the supply chain.

The data is normally available both in structured and unstructured formats. Structured data is a way of storing data efficiently on a computer allowing a variety of critical operations to be performed. The data shared throughout an organization and across the supply chain by the enterprise or the organization is referred as enterprise data.

A large number of third party vendors like ACNielsen and IRI, provide data regarding consumer behavior, market performance and the various segments of a market. This data, sourced from the market research firms, is referred to as syndicated data.

Unstructured data refers to the computerized information that either does not have a data structure or that is not easily readable by a machine.

As a result, there is a lot of data available to the organization originating from the various sources across all the entities of the supply chain. This data available through these multiple sources needs to be collected, integrated, stored, and analyzed to obtain valuable business insights and to take better business decisions.

Thus, consumer product manufacturers and the retailers feel the need to have a business solution that seamlessly bridges diverse business functionality with an advanced analytics platform in order to address the business challenges like effective trade promotions management, product portfolio management, new product introduction, unstructured data analysis, etc.

Therefore, there exists ample opportunity for improvement in technologies related to integrating various data sources in order to provide advanced data analytics solutions.

### SUMMARY

A variety of technologies related to integrating syndicated data, enterprise data, and/or unstructured data, as well as analyzing and reporting based on the integrated data, can be provided.

In one aspect of the technologies described herein, a method for analysis of enterprise data, syndicated data and unstructured data in a business process is provided. The method comprises integrating and mapping the data available from different data sources, internal or external to an organization. The data available includes enterprise data available within the organization, syndicated data available from various market research firms and unstructured data arising out of consumer feedback on the Internet, blogs, etc. Further, the method comprises using functional data models to segregate the integrated data into various data buckets. The data buckets are defined according to the industry of application; for example, in the sales and marketing effectiveness area in the consumer products goods industry the data buckets defined are pricing, brand management, accounts management, new products, promotions etc. In addition, the method comprises applying statistical models to analyze data obtained in prior steps and to define various key performance indicators specific to the industry. Furthermore, the method comprises functional analysis of the key performance indicators to get performance indices. The method also comprises displaying the analysis results and representing the same in the form of scorecards and dashboards. The results can be displayed to the user through a user interface, such as a web browser, electronic mail, or on any pervasive device.

In another aspect, a system for integrating enterprise data, syndicated data and unstructured data in a business process for analysis and reporting is provided. The system includes a data mart or a data repository. Further, the system also includes a metadata builder module. The metadata builder module is used to segregate data obtained from the data mart to various buckets, store the information, and create metadata models which are then used for data representation by the application layer. The metadata builder module extracts metadata from the data obtained to define a structure of data required for the analysis phase. The metadata builder module analyzes the data to obtain fact awareness, dimension awareness, attribute awareness, navigation awareness, hierarchy awareness, aggregate awareness, join awareness, and master data awareness. Further the system includes analytical object configuration tools that help the user perform various analytical operations on the metadata obtained through the metadata builder module. The various components that can be a part of the analytical object configuration tools are a scorecard manager, a dashboard manager, an alerts and notifications handler, a reports manager, a scenario builder, and a root cause analyzer. Each of the components uses the metadata repository and performs different analytical operations on the metadata to give detailed analysis of the enterprise data, syndicated data and the unstructured data to produce output (e.g., reports and recommendations) based on desired results. Furthermore, the system includes statistical model integration tools to build statistical models using the data obtained from the metadata repository. The system also includes a reporting module that generates and displays analysis results to the user. These results can be in the form of alerts, graphs, messages, recommendations, and graphical representation of messages among others.

In yet another aspect, a system for analysis of enterprise and syndicated data in a business process is provided. The system includes a scorecard manager, a dashboard manager, a scenario builder, a statistical modeling platform tool, alert and exception management, and a root cause analyzer. The scorecard manager provides user with a visual depiction of scorecards of various performance indices. The dashboard manager provides flexibility in defining different views for each of the performance indices. Further, the root cause analyzer provides the user with an ability to perform root cause analysis based on statistical models. The statistical models are provided by the statistical model integration tool. Also, the scenario builder is used to create scenarios to understand the cause of a performance of a specific performance index. The scenario builder helps a business user interact with models in a more intuitive manner. The shipment data and the consumption data comparison is done by a Matchmaker Application which is used to visually map product, market and time dimensions for the comparison process.

In yet another aspect, a method for integrating enterprise data and syndicated data can be provided. The method can comprise obtaining enterprise data (e.g., data from a CPG manufacturer such as shipment data), obtaining syndicated data from a syndicated data provider (e.g., comprising retail sales data from one or more retailers of the manufacturer), performing various processing on the enterprise and syndicated data (e.g., recast processing, fringe compensation, event identification, and event matching), and outputting results.

In yet another aspect, a data integration framework for integrating enterprise data, syndicated data, and/or unstructured data can be provided. The framework can comprise a plurality of data extractors (e.g., a data extractor configured to receive enterprise data, a data extractor configured to receive syndicated data, and/or a data extractor configured to receive unstructured data) and a data integration module. For example, the data integration module can be configured to perform syndicated data recast processing on the syndicated data, perform fringe compensation processing on the syndicated data, identify consumption events in the processed syndicated data, match shipment events to consumption events, and store results of the matching.

The foregoing and other features and advantages will become more apparent from the following detailed description, which proceeds with reference to the accompanying figures.

### BRIEF DESCRIPTION OF THE DRAWINGS

FIG. 1 is a block diagram illustrating an example data analytics solution implementing the technologies described herein.

FIG. 2 is a flowchart showing an example method for integrating various data sources.

FIG. 3 is a block diagram illustrating an example architecture for integrating various data sources for analysis and reporting.

FIG. 4 is a flowchart showing an example method for extracting metadata.

FIG. 5 is a diagram illustrating an example process for integrating various data sources in order to provide enterprise strategy management.

FIG. 6 is a diagram illustrating an example process for trade promotion management.

FIG. 7 is a diagram illustrating an example data integration process.

FIG. 8 is a diagram illustrating monthly alignment of syndicated data reporting weeks.

FIG. 9 is an example graph depicting event weeks.

FIG. 10 is a flowchart showing an example method for matching events.

FIG. 11 is a block diagram illustrating an example of a computing environment that can be used to implement any of the technologies described herein.

### DETAILED DESCRIPTION OF EXEMPLARY EMBODIMENTS

### Example 1

### Overview

Generally, the described technologies deal with integration of enterprise data, syndicated data and/or unstructured data to analyze the performance of various key performance indicators across various parameters. The described technologies can be used in various industry applications such as promotion management, brand management, new product introduction, account management, pricing management, store management, etc.

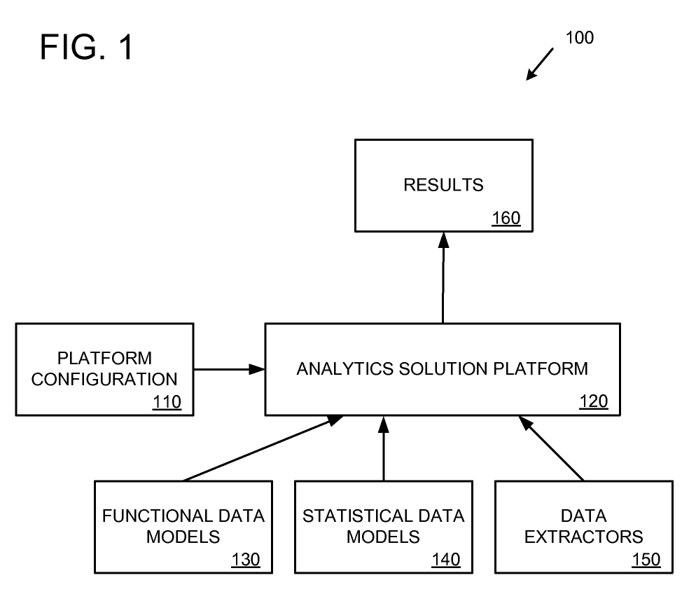

FIG. 1 is a block diagram that illustrates a data analytics solution 100 that can implement the technologies described herein. FIG. 1 shows multiple data sources feeding data to the data analytics solution platform 120. The platform configuration tool 110, allows users to configure the analytics solution platform 120 (which is described below) to suit the business requirements.

The analytics solution platform 120 comprises data extractors 150 to extract data from various data sources (e.g., syndicated data, enterprise data, and unstructured data). Data extracted from various sources is further integrated and functional data models 130 are used to segregate the integrated data into various data buckets defined according to the industry of application. Furthermore, the platform also comprises a statistical model integration tool that is used to develop statistical models 140 for analysis of key performance indicators. The solution 100 provides performance management capabilities using built-in modules (e.g., a scorecard manager, a dashboard manager, a scenario builder, a statistical modeling platform tool, alert and exception management, and a root cause analyzer) which present the analytical results 160 in a user friendly fashion (e.g., formatted reports and recommendations).

### Example 2

### Integration and Mapping of Data Sources

In the technologies described herein, various data sources can be integrated and mapped. Once data has been integrated and mapped, it can be used for various reporting and analysis activities.

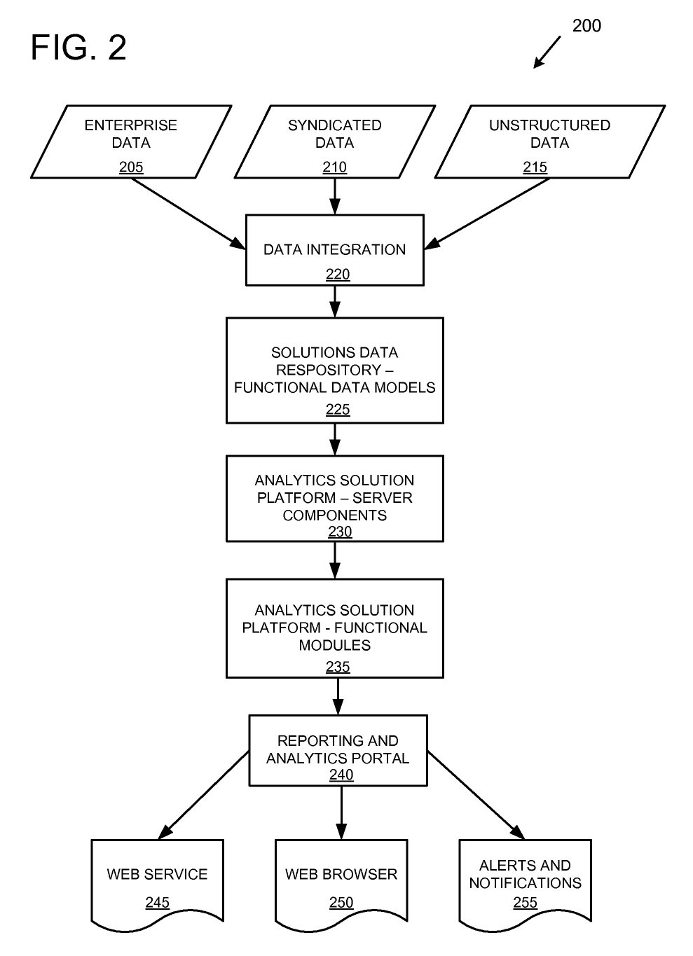

FIG. 2 illustrates a method 200 for integrating and mapping various data sources for analysis and reporting, according to a specific implementation. In the method 200, the data extractors (205, 210, and 215) extract the data from various data sources into the analytics solution platform. Enterprise data 205 (e.g., transactional data such as shipment data of a Consumer Packaged Goods (CPG) manufacturer) is fed by enterprise applications, syndicated data 210 is fed by syndicated data sources (e.g., market research firms such as the ACNielsen service provided by The Nielsen Company and services provided by Information Resources, Inc. (IRI)), and unstructured data 215, which originates from other sources (e.g., consumer feedback on the Internet, blogs, etc.).

The data obtained from the syndicated data sources and the enterprise data sources, along with the unstructured data, is integrated 220 and metadata models are built based on data integration and data mapping. Further, functional data models can be used to segregate the integrated data into various data buckets and create a solution data repository 225. The data buckets can be defined with regard to a specific industry. In a specific implementation, where the industry is the CPG industry, and the application is in the sales and marketing area, the data buckets are defined as: pricing, brand management, accounts management, new products, promotions, etc.

The analytics solution platform 230 comprises various server components, which will be described below. The functional modules 235 used by the analytics solution platform include a scorecard manager, a dashboard manager, a scenario builder, a statistical modeling platform tool, alert and exception management, and a root cause analyzer. In addition, statistical models can be applied to analyze data obtained in prior steps and to define various key performance indicators specific to the industry of concern.

A reporting and analytics portal 240 provides analysis and results. For example, results can be displayed to a user via a web service 245, a web browser 250, or via alerts and notifications 255. This enables the business user to leverage relevant business content to derive actionable insights and to take immediate corrective action in case exceptions arise.

### Example 3

### Integration Architecture

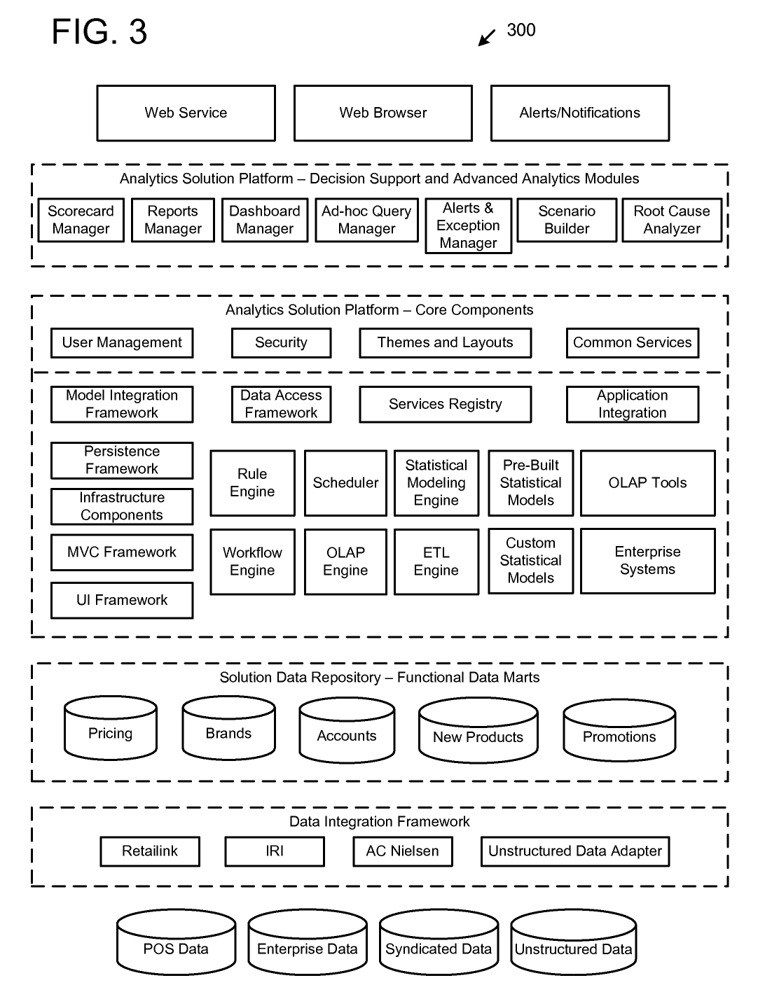

In the technologies described herein, an architecture can be provided for integrating various data sources for analysis and reporting. FIG. 3 depicts a block diagram of an architecture 300 for integrating syndicated data, enterprise data, unstructured data, and/or point-of-sale (POS) data in order to provide analysis and reporting, in a specific implementation.

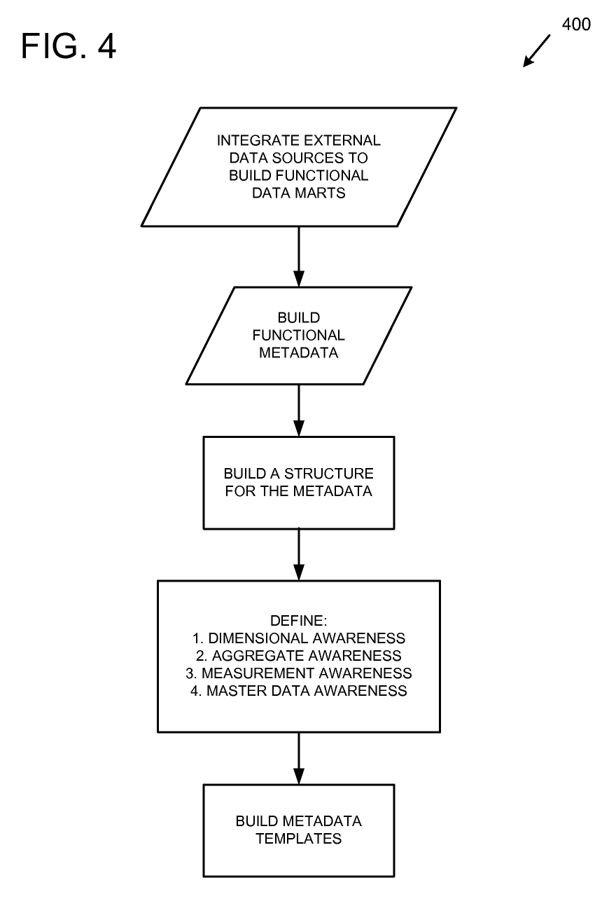

In the data integration architecture shown in FIG. 3, the data from these data sources is integrated using various adaptors and data extractors. Specifically, data adapters are provided for Retail Link (the Retail Link service provided by Wal-Mart Stores, Inc.), IRI, ACNielsen, unstructured data. The data is then segregated into various buckets using functional data models to create the Solution Data Repository or the Functional Data Marts. A metadata builder module is used for this purpose. FIG. 4 illustrates an example method 400 for extracting metadata to create metadata models.

The metadata models obtained through the process of metadata extraction are used in the analytics phase. As shown in FIG. 3, the Analytics Solution Platform—Core Components includes modules used to set up data for analysis and perform various analytical operations. The Core Components include Model Integration Framework, Themes and Layouts, Rule Engine, Pre-built Statistical Models, Custom Statistical Models, etc. These components enable the Analytics Solution Platform—Decision Support and Advanced Analytics Modules to produce relevant and appropriate analytical results. The Decision Support and Advanced Analytics Modules include Scorecard Manager, Dashboard Manager, Scenario Builder, Root Cause Analyzer, Alert and Exception Manager, and Report Manager.

For example, the Scenario Builder can assist with the analysis of various scenarios. Such scenarios can include base and incremental volumes for various promotional strategies, regular and base pricing points independent of similar values provided by syndicated data providers, and impact of special pack grouping.

Also depicted in FIG. 3 are Enterprise Systems. For example, the Enterprise Systems can include SAP enterprise resource planning (ERP) systems. The system 300 can include adapters for interacting with various ERP systems.

According to a specific implementation, the scorecard manager provides the ability to disseminate strategy and initiatives by visual depiction of scorecards as well as measure the performance effectiveness. Further, the scorecard manager provides the option of cascading scorecards to help drill-down the initiative to the users in a consistent form. The initiatives can be compared at peer levels and benchmarked against best performers. Laggards can be filtered out and put on course correction. A Category Analytics Homepage can be provided that lets users select a representation type for Key Performance Indicators (KPIs)/business functions. Additionally, a user can select a measure type to be displayed for each business function (actual, plan, budget, last year, variance with plan, variance with budget and performance indicators, etc). Further, the homepage provides the ability to select a layout of the scorecard based on the business function representation type. Indicators showing the behavior of the KPI variance with respect to multiple dimensions like geography (color coded geographical map/heat map), time, and channel are also provided with the scorecard manager. The Scorecard Manager provides the ability to customize based on the user's organizational reporting structure (roles) and offers flexibility to incorporate business rules, and assign user/data/dimension/screen/functionality based access rights.

Further, as seen in FIG. 3, the Decision Support and Advanced Analytics Modules includes the Dashboard Manager. The Dashboard Manager provides users with trend graphs and signal graphs to show trends in data. Further, the Dashboard Manager provides users with a multi-dimensional view to pick and choose the desired snapshot.

The Scenario Builder, as seen in FIG. 3, is used to perform KPI based analysis, create business scenarios, perform what-if analysis and analyze the cause of performance of a specific KPI. It provides users with various charts such as the Ishikawa Fishbone structure, quadrant analysis, and waterfall charts.

A Hierarchy Manager (one of the Decision Support and Advanced Analytics Modules depicted in FIG. 3) lets users of the system create custom groups based on dimensions by clubbing items across levels in a dimension. For example in product hierarchy a custom group can be created by dimensions such as products and attributes like size, flavor, color, etc. The Hierarchy Manager also provides cross dimensional custom groups by selecting components across multiple dimensions like product, customer or geography and clubs them in one group. The custom grouping functionality helps business users carry out on-the fly analysis and make swift business decisions. The custom groups can also be maintained in the user's environment for further usage.

The Reports Manager shown in FIG. 3 provides options to integrate with enterprise reporting tools that exist in the market. Further, it also provides advanced analytics functions, scorecards and reports to create integrated view information.

The system of FIG. 3 further includes the Alerts and Exception Manager which helps users identify exceptions with respect to scorecards, KPIs, reports, etc. Further, the Alerts and Exception Manager also lets users to store and keep track of actions taken for historical alerts. A Rule Engine is also provided that lets users modify and customize business rules to suit a specific business scenario.

In a specific implementation, an intuitive interface (e.g., a graphical user interface (GUI)) is provided that lets users obtain analysis results for business processes using multiple data sources in three clicks. When a user begins the analysis process the user selects the desired measure, dimension, or key performance indicator to monitor or analyze. With the help of metadata, various representations of the analytical results are available to the user via tracking performance of the key performance indicators in a KPI dashboard. In addition, what-if analyses of different scenarios of a business process are available by way of different charts and graphs, performance heat maps, root cause analyses for the performance of a particular KPI by way of Ishikawa diagrams, geography-wise analyses of sales of products/services with the help of geographical heat maps, etc. The user can select various representations of the analysis results from a set of charts such as pie charts, bar charts, fish-bone diagram, waterfall chart, and calendar representation. Further, users can set alerts for specific business rules. The alerts notify users when the specific business rule is met. For example, a user may want to be notified when unit sales at a certain location fall below a threshold. The system will send a notification to the user through a user selected mode (e-mail, color coded alerts on the dashboard, etc.) when the business rule is met. The user can customize and modify rules and alerts to fit the user's requirements.

To explain the three click method, consider the example of analysis of a trade promotion. Assume that a Vice President of a CPG company wants to study the performance of a trade promotion strategy he has recently implemented. Using the system he can do so in three clicks. The VP goes to the promotions page. The VP can then analyze a promotion by creating a promotion scorecard for a promotion and track it. The promotion scorecard allows the user to track performance across various regions and also analyze each KPI in detail. Features like pie-chart analysis provide the person with in-depth analysis. To summarize, the user can drill down from a scorecard to a dashboard and then arrive at an actionable item view, in just three clicks.

### Example 4

### Integration of Data for Enterprise Strategy Management

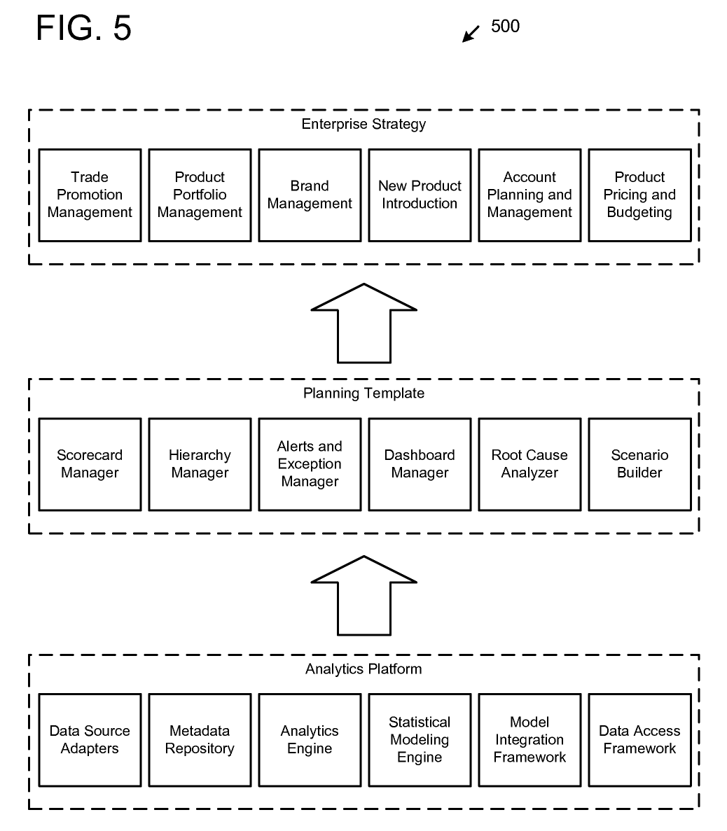

In the technologies described herein, various data sources (e.g., enterprise and syndicated data) can be integrated to provide solutions for enterprise strategy management. FIG. 5 depicts an example process for integrating syndicated data and enterprise data (and optionally other types of data) in order to provide enterprise strategy management. Using the process depicted in FIG. 5, various analytical results can be represented in the form of a planning template, scorecards, dashboards, etc. These results enable a business user to make insightful decisions regarding the overall enterprise strategy.

For example, consider the task of trade promotion management. The system depicted in FIG. 3 can be adapted to implement the process depicted in FIG. 5 to provide for efficient management of the trade promotion process.

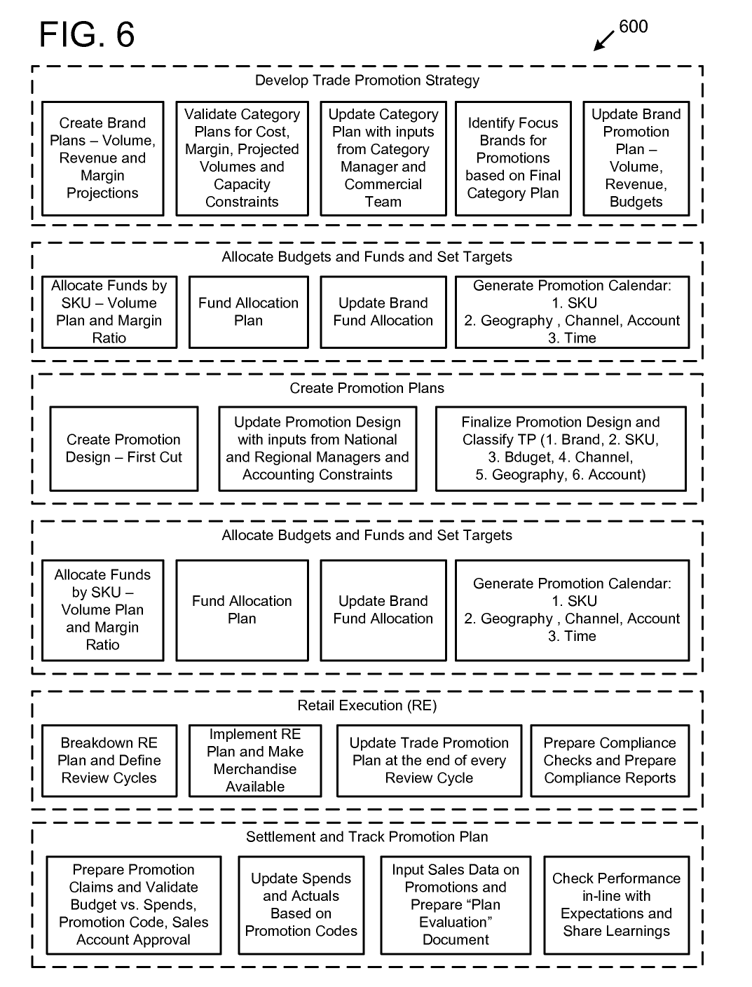

FIG. 6 depicts another example process for trade promotion management, in a specific implementation. For example, the trade promotion process depicted in FIG. 6 can be implemented via the system depicted in FIG. 3.

In the consumer packaged goods and the retail industry, trade promotions management is an important aspect in overall supply chain management. The trade promotions strategy is developed by creating and validating the brand promotions plans. Then, targets are determined and trade promotions budgets and funds are allocated. This is accomplished by developing the fund allocation plan and then generating a promotions calendar. With the help of these resources, promotion designs are created. Subsequently, sell-in/negotiate promotions plans are developed by creating a sales account plan and generating an execution customization report. Next, in the retail execution stage, the trade promotional plans are updated at the end of every review cycle and the compliance reports are prepared. Finally, promotional effectiveness is evaluated (e.g., by comparing actual results to expected results).

The historical data of these promotional campaigns is provided for analysis of various trade promotions. This historical data can be used to create trade promotion scenarios that are provided to users as analytical results. These scenarios take into consideration the effect of historical trade promotion campaigns for a particular brand or a product category from the same company. The historical data analysis provides insight into whether a particular trade promotion campaign adversely affected the sales of a product of the same company (cannibalization). Users can use these insights to successfully plan their future trade campaigns. Further, for a particular product based on historical data, various scenarios are built that let a user understand the effect of a particular campaign on the sales of that product. The analysis results obtained, according to a specific implementation, provide insight in multidimensional data points (e.g., finance, marketing, sales and distribution). Further, the technologies described herein provide analysis of unstructured data to business users, which help in qualitative analysis of the customer's perception of a trade promotion campaign.

### Example 5

### Roles

Table 1 below illustrates various roles existing in the retail industry and the CPG industry and how they can use the various technologies described herein.

TABLE 1
Roles
Retail

| | Merchandisers, | | |
|---|---|---|---|
| Operations | Category | Marketing | |
| Managers | Managers | Managers | Store Expansion |
| Performance | Create | Which promotions | Set benchmark |
| improvement | benchmarks for | are yielding best | targets for new |
| through store | initiatives based on | results, why | store openings |
| benchmarking | historic | Mid-course | Track new store |
| Disseminate best | performance | correction to promo | performance against |
| practices to | Regions/clusters | roll-outs | initial objectives |
| underperformers | that best respond to | Track key | Identify most |
| What is causing | category initiatives | parameters that | effective store sizes, |
| store growth | and why | impact promo | store formats |
| Promos/ | Prioritizing | execution | Store asset |
| productivity/ | category execution | Which regions/ | utilization, |
| footfall/availability | based on root-cause | clusters respond | productivity |
| Monitoring store | analysis | best to which | Monitor, compare, |
| productivity | Tracking new | promotion | alert |
| improvement | product | Allocation of | |
| initiatives | introductions | promotion assets for | |
| Store manager | | best results | |
| scorecards, | | | |
| exception-based | | | |
| alerts | | | |

CPG

| | | National Account | Regional Sales |
|---|---|---|---|
| Brand Manager | Category Manager | Manager | Manager |
| Create brand | Create category | Negotiating with | Improve |
| promotions plans - | plans - aggregate | retailers to create | performance of |
| volume, revenue | brand plans | account plans | brand trade |
| and margin | Identify focus | Manage brand | promotions |
| projections | brands for | fund allocation | Evaluation |
| Allocate funds by | promotions | Execute | promotion with |
| SKU —volume plan | Approve brand | promotions plan | respect to |
| and margin ratio | promotions | Evaluate | merchandising, |
| Generate | Monitor brand | execution | competitor |
| promotions | fund allocation in | customization | information and |
| calendar by - SKU, | collaboration with | report | pipeline stock |
| geography, channel, | account managers | | Manage brand |
| account and time | | | fund allocation |
| Create promotion | | | Develop new |
| design and classify | | | promotion requests |
| trade promotion | | | to the brand |
| | | | managers |

### Example 6

### Integration Overview

This section describes a generalized overview of the data integration process. This data integration process integrates enterprise data, syndicated data and/or unstructured data, and can be used to analyze the performance of various key performance indicators across various parameters. The technologies described herein can be used in various industry applications such as promotion management, brand management, new product introduction, account management, pricing management, store management, etc.

In a specific implementation, data integration is performed along three main data dimensions. The first dimension is the product dimension. In the product dimension, product mapping is performed in two ways. The first product mapping maps internal Universal Product Code (UPC) data to syndicated UPC data. The second product mapping maps internal sales pack (e.g., a group of the same or similar products) to syndicated sales pack data. Sales pack mapping can be important if event and return on investment (ROI) calculations are performed at the sales pack level.

The second dimension is the market dimension. The market dimension is mapped at three levels: account level, planning level, and planning group level.

The third dimension is the time dimension. A goal of the time dimension mapping is to be able to match shipment commitment data to consumption event data so that return on trade investments can be calculated, reported, and analyzed (and potentially optimized). Time dimension mapping is performed as follows:
Transform shipment volume, trade spend and cost data from stock number/SKU level to sales pack level.
Perform syndicated data recast.
Identify of consumption event windows.

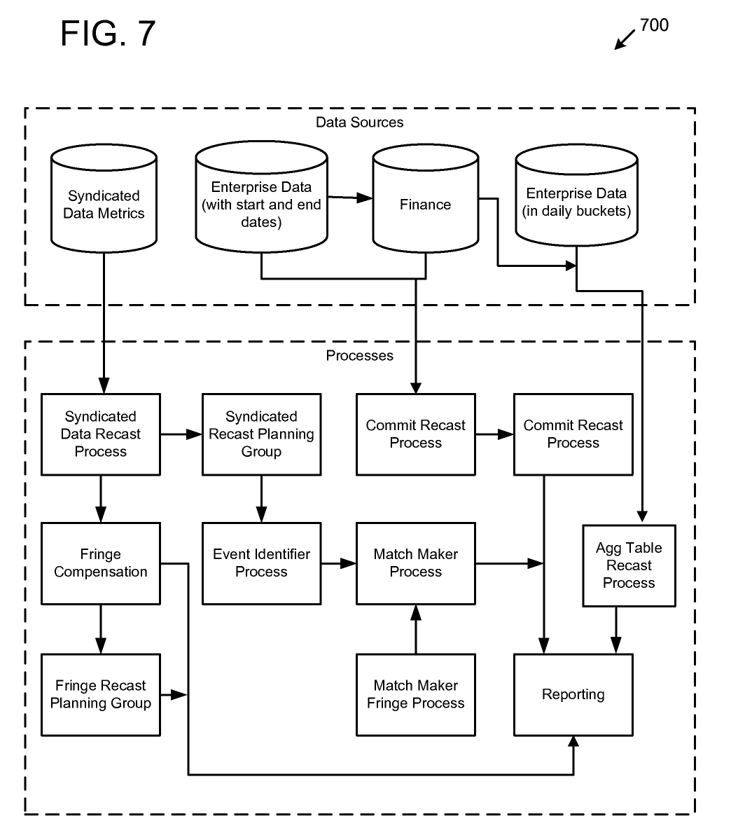

In a specific implementation, a nine-step process is used to prepare data for reporting purposes. This implementation is depicted in FIG. 7.

The first step in the nine-step process 700 is a syndicated data recast step. Syndicated data recast is needed when the syndicated data provider uses a different week than the retailer. For example, ACNielsen reports data on a weekly basis starting on a Sunday and ending on a Saturday. However, retailers may or may not use the same week (e.g., a specific retailer may report volume and activity on a weekly basis starting on a Friday and ending on a Thursday).

The second step is fringe compensation. Fringe compensation is needed because syndicated data providers report on a weekly basis and CPG companies may need monthly reporting. With fringe compensation, syndicated data is matched to calendar months.

The third step is syndicated data recast planning group. In this step, syndicated data is associated with a particular planning group (e.g., by geography or channel of distribution).

The fourth step is syndicated data fringe planning group (e.g., to compensate for differences in geography or channel).

The fifth step is commit recast. For a CPG company that does not have a separate UPC hierarchy, the UPCs need to be mapped to the syndicated data provider UPC hierarchy. This function is done by the commit recast process. Therefore, the identification of the UPCs and the transformation is done by this process. This step uses a start date and an end date. Commit data recast process can be used to:
convert physical cases into units
split a mixed pallet commitment, and
associate fixed/manufacturer/distribution costs to a commitment.

The sixth step is commit recast fringe. This step is used for converting physical cases to units, splitting a mixed pallet commitment, associate fixed/manufacturer/distribution costs to a commitment and fringed for calendar reporting.

The seventh step is aggregate table recast process. The aggregate table recast process is used to convert physical cases into units, split a mixed pallet commitment, and associate fixed/manufacturer/distribution costs to a commitment. This step uses daily data.

The eighth step is the event identifier step. The event identifier process works in the following manner:
Identification of syndicated data event weeks
Identification of event start dates
Identification of event end dates
Modify syndicated event dates
Event type identification: Event type values can be one of the following:
   Any feature
   Any display
   Feature and display
   Discount/temporary price reduction (TPR)

The ninth step is the match maker process. The goal of this step is to be able to match shipment commitment data to consumption event data so that return on trade investments can be calculated, reported, analyzed, and optimized. This can be achieved in the following manner:
Transformation of shipment volume, trade spend & cost data from stock number/SKU level to sales pack level.
Perform recast processing so that syndicated data is aligned with CPG company data.
Identification of consumption event windows (Event Identifier).
Matching of re-casted shipment data to consumption events.

### Example 7

### Syndicated Data Recast

In the technologies described herein, syndicated data can be recast in order to make analysis and reporting easier. Generally, when syndicated data providers (e.g., ACNielsen and IRI) collect data, they perform various processing before selling the data to a CPG company. As a result of the data processing, formatting, and/or arrangement performed by the syndicated data providers, the data received by the CPG company may not accurately reflect retail consumption. For example a specific retailer may report volume and promotional activity to the syndicated data provider on a weekly basis beginning on a Wednesday and ending on a Tuesday. However, the syndicated data provider may organize data on a different weekly basis (e.g., ACNielsen organizes data on a weekly basis beginning on a Sunday and ending on a Saturday).

This discrepancy in weekly alignment between syndicated data providers and retailers can be problematic when trying to integrate data and produce meaningful and accurate results. For example, consider the situation where a retailer sells 200 units of product in a promotion week, which is 100 units over typical sales, a 100% increase for the week. If the syndicated data provider organizes results in weeks that do not align with the retailer's weeks, then the promotion results will be skewed. For example, the syndicated data results may report a 30 unit increase in one week and a 70 unit increase in the next week. The result is that the effectiveness of the promotion is not correctly reflected in the results provided by the syndicated data provider, thus limiting the ability to correctly evaluate the effectiveness of the promotion. For example, un-aligned results of reported base and incremental volumes and activity information can significantly skew return-on-investment (ROI) values.

In a specific implementation, syndicated data from ACNielsen is recast using the following procedure for retailer volume reporting:
Retailers reporting volume data to ACNielsen on Sun-Sat, Mon-Sun, and Tue-Mon are aligned with the same ACNielsen week.
Retailers reporting volume data to ACNielsen on Wed-Tue, Thu-Wed, Fri-Thu, and Sat-Fri are aligned with the next ACNielsen week.

In some cases, a retailer may not report volume data on the same weekly schedule as promotion data. For example, a specific retailer may report volume data based on 7 days starting Sunday and ending Saturday, but report promotional activity on a different 7 days starting Wednesday and ending Tuesday. In a specific implementation, syndicated data from ACNielsen is recast using the following procedure for retailer promotion reporting:
Retailers reporting promotion activity to ACNielsen on Sun-Sat, Mon-Sun, Tue-Mon, Wed-Tue, and Thu-Wed are aligned with the same ACNielsen week.
Retailers reporting promotion activity to ACNielsen on Fri-Thu and Sat-Fri are aligned with the next ACNielsen week.

### Example 8

### Fringe Compensation

In the technologies described herein, syndicated data as well, as CPG, data may need to be adjusted to fit within a calendar monthly reporting period. Generally, in order to obtain accurate and complete reporting between internal and external metrics, data should be aligned in the time dimension (e.g., monthly).

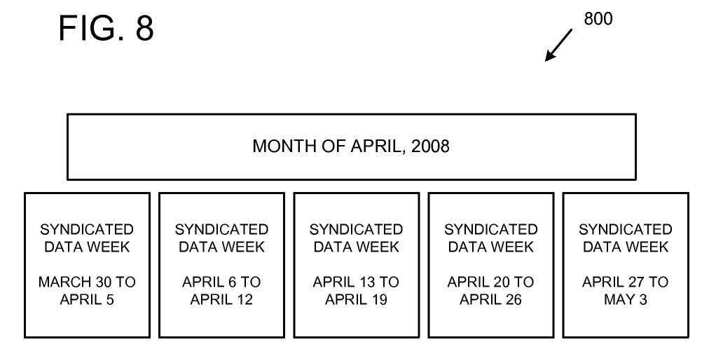

In a specific implementation, ACNielsen data (which reports on a weekly basis ending Saturdays) is compensated. This fringe compensation process can be illustrated by considering the month of April, 2008. For the month of April, 2008 (Apr. 1, 2008 through Apr. 30, 2008), ACNielsen data is reported over 5 weeks as follows:
Week ending April 5^{th}
Week ending April 12^{th}
Week ending April 19^{th}
Week ending April 26^{th}
Week ending May 3^{rd}
   As illustrated above, there are two fringe weeks for April, 2008. Specifically, the first week (ending April 5^{th}) contains two days at the end of March, and the fifth week (ending May 3^{rd}) contains three days from May. FIG. 8 depicts an illustration 800 of the month of April, 2008, along with the five syndicated data reporting weeks. Note that in the illustration 800, there are two days in the first reporting week from March, and three days in the fifth reporting week from May.

In the specific implementation for performing fringe compensation for syndicated data (e.g., syndicated data from ACNielsen), the following procedure is used:
Syndicated data volume and dollar related metrics are adjusted based on the number of days that fall into the calendar month.
   In order to calculate the modified volume or dollar amounts, the reported amount is divided by 7 to obtain daily amount, and the result is then multiplied by the number of days of the fringe week that fall within the month at issue. Modified amount=(reported amount/7)*days
   Using the above example for April, 2008, for the ACNielsen week ending April 5^{th}, 5 days fall into April and 2 days fall into March. If ACNielsen reported volume of 7,000 units and sales of $14,000, then fringe compensation for this week would result in 5,000 units and $10,000.
   (7,000 units/7)=5=5,000 units
   ($14,000/7)*5=$10,000
All other metrics, such as all actual commodity value (ACV) and price related metrics, are kept the same.

Similarly, in the specific implementation, CPG shipment commitments are adjusted. For example, a commitment that starts on April 25^{th} and ends on May 5^{th}, where 5 days of the commitment is in May, needs to be adjusted when calculating metrics for April. In the specific implementation, CPG shipment commitments are adjusted as follows:
All volume, dollar, and total trade costs are split based on the number of days within/outside the month (as described above with regard to the syndicated data)
All prices and rates are kept the same.

### Example 9

### Event Identifier

In the technologies described herein, consumption events can be identified within syndicated data. Syndicated data is provided on a weekly basis and is organized by SKU, time, and promotion types in ACV values. For example, with ACNielsen data, four promotion types are provided: discount/temporary price reduction (TPR), display, feature, and feature and display.

In a specific implementation, events are identified (e.g., identification of consumption event windows) in syndicated data using the following procedure:

Step 1—identification of event weeks in syndicated data. In this step, trigger values (e.g., threshold values) are used to identify event weeks in syndicated data. An example of a trigger value is when a display is over a specified percentage ACV (e.g., a user-defined percentage) then the week is identified as an event week. Different trigger values may be needed for different products.

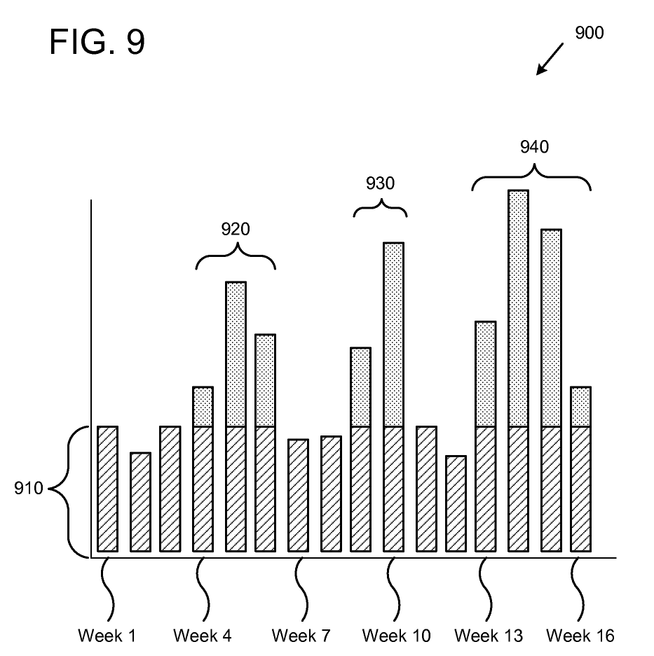

FIG. 9 is an example graph 900 depicting event weeks. In the graph 900, the x-axis represents weeks and the y-axis represents retailer unit volume. A trigger value is set 910 at a specific unit volume. Values above the trigger value are considered a result of promotion activity. In the graph 900, there are three groups of weeks identified as promotion weeks, 920, 930, and 940.

Step 2—identification of event start dates. In this step, the process starts from week 1 and checks every consecutive week until the last week of data. If the current week is a promotion event week and the previous week is not a promotion event week, then the current week is set to an event start date.

Step 3—identification of event end dates. In this step, the process starts from week 1 and checks every consecutive week until the last week of data. If the current week is an event week and the next week is not an event week, then the current week is set to an event end date.

For example, in the graph 900, there are three event windows. The first event window 920 begins with week 4 and ends with week 6. The second event window 930 begins with week 9 and ends with week 10. The third event window 940 begins with week 13 and ends with week 16.

Step 4—modify event dates. In this step, a user can modify event dates as needed (e.g., identify new event weeks, change event start or end weeks, etc.).

Step 5—identify event type. Event types are identified as one of the following: any feature, any display, feature and display, and discount. In this specific implementation, the following procedure is used to identify event types:
First, get the max ACV value of each activity for the whole event duration.
Next, based on the combination of the max ACV values identified and the thresholds, event type can be determined as follows.
   IF MAX Any Feature>Any Feature Threshold AND MAX Any Display<Any Display threshold THEN, Event Type=FEATURE ONLY EVENT
   IF MAX Any Feature>Any Feature Threshold AND MAX Any Display>Any Display threshold THEN, Event Type=FEATURE & DISPLAY EVENT
   IF MAX Any Feature<Any Feature Threshold AND MAX Any Display>Any Display threshold THEN, Event Type=DISPLAY ONLY EVENT
   IF MAX Any Feature<Any Feature Threshold AND MAX Any Display<Any Display threshold AND Discount>Discount Threshold THEN, Event Type=TPR EVENT
The following default threshold values are used. However, these values can be edited as needed.
Any Feature Threshold=10% ACV
Any Display Threshold=10% ACV
Discount Threshold=5%
Discount % is the difference between the Average Price and Base Price (e.g., from ACNielsen).
Discount %=(Base Retailer Price−Average Price)/Base Retailer Price

### Example 10

### Match Maker

In the technologies described herein, event windows can be matched to shipment data. The event identification process produces a list of promotions (events) with start and end dates. The match maker process takes CPG company shipment data and matches it to event windows.

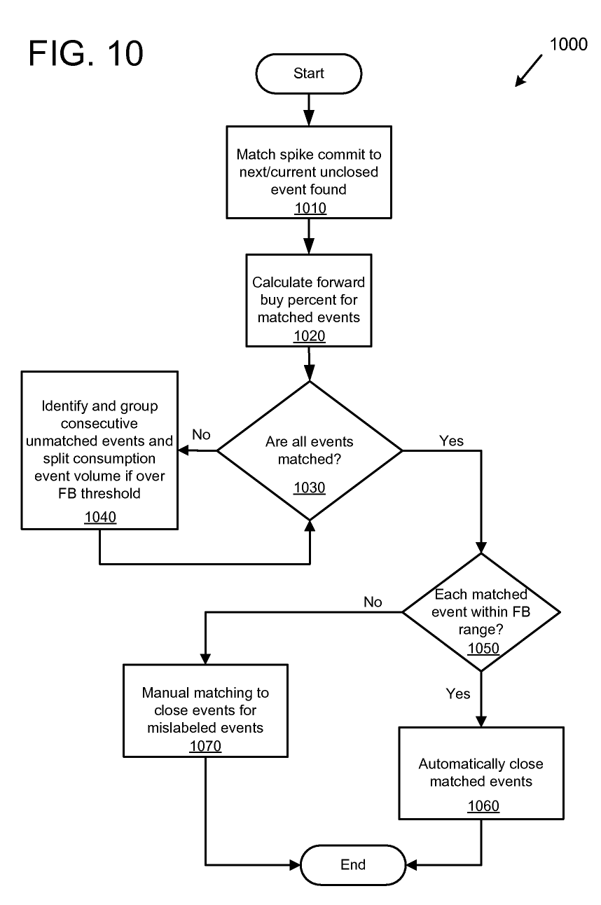

FIG. 10 is a flowchart 1000 depicting an example method for matching events to shipment data. At 1010, shipment events (obtained from CPG company data) are matched to consumption events (events identified within the syndicated data). In a specific implementation, shipment events are matched to the next consumption event occurring within a threshold number of weeks (e.g., 8 weeks).

At 1020, the forward buy (FB) percentage is calculated for matched events. The forward buy percentage is calculated as follows: FB=(syndicated data event volume−matched commitment volume)/syndicated data event volume.

At 1030, a check is made to determine if all the consumption events have been matched.

At 1040, if all the events have not been matched, then consecutive unmatched events are grouped. In addition, if a consumption event is not matched, then the previous consumption event is checked for a significant FB value (e.g., over a threshold value). In such a case, the previous shipment event can be split so that it matches the consumption event.

At 1050, a check is made to determine whether all the consumption events have been matched to within a FB range (e.g., within a pre-set range). If so, all matched events are closed at 1060. If not, then manual intervention is required 1070.

### Example 11

### Exemplary Computing Environment

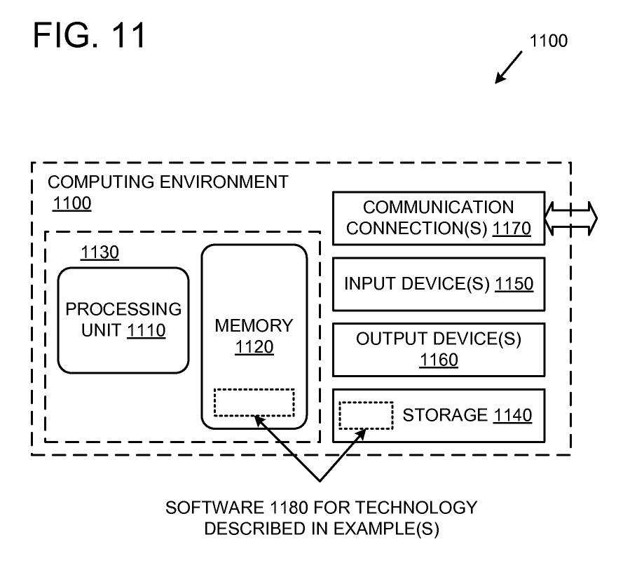

FIG. 11 illustrates a generalized example of a suitable computing environment 1100 in which described embodiments, techniques, and technologies may be implemented. The computing environment 1100 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 11, the computing environment 1100 includes at least one central processing unit 1110 and memory 1120. In FIG. 11, this most basic configuration 1130 is included within a dashed line. The central processing unit 1110 executes computer-executable instructions and may be a real or a virtual processor. In a multi-processing system, multiple processing units execute computer-executable instructions to increase processing power and as such, multiple processors can be running simultaneously. The memory 1120 may be volatile memory (e.g., registers, cache, RAM), non-volatile memory (e.g., ROM, EEPROM, flash memory, etc.), or some combination of the two. The memory 1120 stores software 1180 that can, for example, implement the technologies described herein. A computing environment may have additional features. For example, the computing environment 1100 includes storage 1140, one or more input devices 1150, one or more output devices 1160, and one or more communication connections 1170. An interconnection mechanism (not shown) such as a bus, a controller, or a network, interconnects the components of the computing environment 1100. Typically, operating system software (not shown) provides an operating environment for other software executing in the computing environment 1100, and coordinates activities of the components of the computing environment 1100.

The storage 1140 may be removable or non-removable, and includes magnetic disks, magnetic tapes or cassettes, CD-ROMs, CD-RWs, DVDs, or any other medium which can be used to store information and which can be accessed within the computing environment 1100. The storage 1140 stores instructions for the software 1180, which can implement technologies described herein.

The input device(s) 1150 may be a touch input device, such as a keyboard, keypad, mouse, pen, or trackball, a voice input device, a scanning device, or another device, that provides input to the computing environment 1100. For audio, the input device(s) 1150 may be a sound card or similar device that accepts audio input in analog or digital form, or a CD-ROM reader that provides audio samples to the computing environment 1100. The output device(s) 1160 may be a display, printer, speaker, CD-writer, or another device that provides output from the computing environment 1100.

The communication connection(s) 1170 enable communication over a communication medium (e.g., a connecting network) to another computing entity. The communication medium conveys information such as computer-executable instructions, compressed graphics information, or other data in a modulated data signal.

Computer-readable media are any available media that can be accessed within a computing environment 1100. By way of example, and not limitation, with the computing environment 1100, computer-readable media include memory 1120, storage 1140, communication media (not shown), and combinations of any of the above.

### Example 12

### Exemplary Automated Methods

Any of the methods described herein can be performed via one or more tangible computer-readable storage media having computer-executable instructions for performing such methods. Operation can be fully automatic, semi-automatic, or involve manual intervention.

### Example 13

### Exemplary Combinations

The technologies of any example described herein can be combined with the technologies of any one or more other examples described herein.

### Example 14

### Exemplary Alternatives

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, implemented at least in part by a computing device, for integrating enterprise data and syndicated data, the method comprising:
obtaining enterprise data, wherein the enterprise data comprises shipment data of a manufacturer;
obtaining syndicated data from a syndicated data provider, wherein the syndicated data comprises consumption data from one or more retailers of the manufacturer;
performing syndicated data recast processing on the syndicated data;
performing fringe compensation processing on the syndicated data;
identifying consumption events in the processed syndicated data;
identifying shipment events in the enterprise data;
matching the shipment events to the consumption events; and
outputting results of the matching.

2. The method of claim 1 wherein the performing syndicated data recast processing compensates for discrepancies in weekly alignment between the syndicated data provider and the one or more retailers.

3. The method of claim 1 wherein the performing fringe compensation processing comprises adjusting volume and dollar amounts of the syndicated data to fit within calendar months.

4. The method of claim 1 wherein identifying the consumption events comprises:
identifying event weeks in the syndicated data;
identifying event windows in the syndicated data, wherein an event window comprises one or more event weeks;
identifying a start date and an end date for each event window; and
determining an event type for each event window.

5. The method of claim 4 wherein the event type is one of: any feature, any display, feature and display, and discount.

6. The method of claim 4 wherein the event weeks are identified using a threshold value.

7. The method of claim 1 wherein matching the shipment events to the consumption events comprises calculating a forward buy percentage for matched events.

8. The method of claim 1 wherein matching the shipment events to the consumption events comprises splitting shipment events when a forward buy percentage of the shipment event is above a threshold value.

9. The method of claim 1 wherein the results of the matching comprises a listing of shipment events and their associated consumption events.

10. A data integration framework for integrating enterprise data and syndicated data, the framework comprising:
a plurality of data extractors, wherein the plurality of data extractors comprise a data extractor configured to receive enterprise data and a data extractor configured to receive syndicated data; and
a data integration module, wherein the data integration module is configured to:
perform syndicated data recast processing on the syndicated data;
perform fringe compensation processing on the syndicated data;
identify consumption events in the processed syndicated data;
identify shipment events in the enterprise data;
match the shipment events to the consumption events; and
store results of the matching.

11. The framework of claim 10 wherein the enterprise data represents shipment data of a manufacturer, and wherein the syndicated data represents consumption data obtained from a retailer of the manufacturer.

12. The framework of claim 10 wherein the plurality of data extractors store the received data in a plurality of data buckets, wherein the plurality of data buckets comprise a pricing data bucket, a brand management data bucket, an accounts management data bucket, a new products data bucket, and a promotions data bucket.

13. The framework of claim 10 wherein the plurality of data extractors further comprise a data extractor configured to receive unstructured data.

14. The framework of claim 10 wherein the wherein the syndicated data recast processing compensates for discrepancies in weekly alignment between the syndicated data provider and the enterprise data.

15. One or more computer-readable media comprising computer-executable instructions for causing a computing device to perform a method for integrating enterprise data and syndicated data, the method comprising:
obtaining enterprise data, wherein the enterprise data comprises shipment data of a manufacturer;
obtaining syndicated data from a syndicated data provider, wherein the syndicated data comprises consumption data from one or more retailers of the manufacturer;
performing syndicated data recast processing on the syndicated data;
performing fringe compensation processing on the syndicated data;
identifying consumption events in the processed syndicated data;
identifying shipment events in the enterprise data;
matching the shipment events to the consumption events; and
outputting results of the matching.

16. The one or more computer-readable media of claim 15 wherein the performing syndicated data recast processing compensates for discrepancies in weekly alignment between the syndicated data provider and the one or more retailers.

17. The one or more computer-readable media of claim 15 wherein the performing fringe compensation processing comprises adjusting volume and dollar amounts of the syndicated data to fit within calendar months.

18. The one or more computer-readable media of claim 15 wherein identifying the consumption events comprises:
identifying event weeks in the syndicated data;
identifying event windows in the syndicated data, wherein an event window comprises one or more event weeks;
identifying a start date and an end date for each event window; and
determining an event type for each event window.

19. The one or more computer-readable media of claim 15 wherein matching the shipment events to the consumption events comprises calculating a forward buy percentage for matched events.

20. The one or more computer-readable media of claim 15 wherein matching the shipment events to the consumption events comprises splitting shipment events when a forward buy percentage of the shipment event is above a threshold value.
